(19) United States
(12) Patent Application Publication
(10) Pub. No.: US 2026/0048645 A1
(43) Pub. Date: Feb. 19, 2026

(54) Support Mechanism and Support Assembly for Soft Top of Truck Bed

(71) Applicant: CHANGZHOU SUNWOOD INTERNATIONAL TRADING CO., LTD., Changzhou (CN)

(72) Inventors: Hang SHI, Changzhou (CN); Hongjuan ZHENG, Changzhou (CN)

(73) Assignee: CHANGZHOU SUNWOOD INTERNATIONAL TRADING CO., LTD., Changzhou (CN)

(21) Appl. No.: 18/805,618

(22) Filed: Aug. 15, 2024

(51) Int. Cl. B60J 7/10

(52) U.S. Cl. CPC B60J 7/102

(57) ABSTRACT

The provided are a support mechanism and support assembly for a soft top of a truck bed. The support mechanism includes a side rail, a first folding assembly, and a second folding assembly, where the side rail is fixed to the truck bed; the first folding assembly includes a first main support frame that is rotatably provided on the side rail; a bottom end of the first main support frame is connected to a movable component; the movable component is rotatably connected to the side rail, such that the bottom end of the first main support frame is adjustable at least along a length direction of the side rail; the second folding assembly includes a second main support frame; the second main support frame is rotatably provided on the side rail; and the second folding assembly is foldable and storable above the first folding assembly.

### TECHNICAL FIELD

The present disclosure relates to the technical field of pickup truck bed covers and in particular to a support mechanism and support assembly for a soft top of a truck bed.

### BACKGROUND

The existing pickup truck bed cover is formed by a hard top plate or a soft top tarp. The tarp is unfolded by a side rail and can be folded when not in use. For example, Patent CN207000128U provides a folding cover assembly for a pickup truck bed, where the frame is vertical after being folded, occupying a large amount of space.

### SUMMARY

In order to solve the problem that the existing soft top support assembly occupies a large space after being folded, the present disclosure provides a support mechanism and support assembly for a soft top of a truck bed, which feature small space occupation after being folded.

In order to solve the above technical problems, the present disclosure adopts the following technical solutions.

A support mechanism for a soft top of a truck bed, including:
a side rail, fixed to the truck bed; and
a first folding assembly, including a first main support frame, where the first main support frame is rotatably provided on the side rail; and
where, a bottom end of the first main support frame is connected to a movable component; and the movable component is rotatably connected to the side rail, such that the bottom end of the first main support frame is adjustable at least along a length direction of the side rail.

Further, the support mechanism further includes a second folding assembly, where the second folding assembly includes a second main support frame; the second main support frame is rotatably provided on the side rail; and the second folding assembly is foldable and storable above the first folding assembly.

Further, the second main support frame is bent, such that a portion of the second folding assembly folded and stored above the first folding assembly is in a flat state.

Further, the first main support frame is connected to the side rail through the movable component; and the movable component is slidably or rotatably connected to the main support frame.

Further, the first folding assembly further includes at least one first auxiliary support frame provided on the first main support frame.

Further, the first auxiliary support frame and the first main support frame are rotatably connected and each are provided with a first positioning structure.

Further, the second folding assembly further includes at least one second auxiliary support frame provided on the second main support frame.

Further, the second auxiliary support frame and the second main support frame are rotatably connected and each are provided with a second positioning structure.

Further, the support mechanism further includes a support strap, where the support strap includes one end fixed to the first main support frame and the other end fixed to the second main support frame.

Further, the side rail is fixed to the truck bed through a fixture.

The present disclosure further provides a support assembly for a soft top of a truck bed, including:
a side rail, fixed to the truck bed; and
a first folding assembly, including a first main support frame; and
a rotating rod, where the side rail is fixed to or integrated with a hinge seat; and the rotating rod includes a first end hinged to the hinge seat and the other end hinged to the first main support frame. When the first main support frame is supported, the rotating rod rotates to a front end. That is, the first main support frame is close to the cab as a whole. In this way, the main support rod is located as close to the cab as possible, providing better support for the soft top. After the first main support frame is folded, the rotating rod is close to the rear end. At this point, the first main support frame rotates as a whole to the rear end. When the first main support frame is folded forward, it will not interfere with the cab and can be folded flat without occupying space or affecting the folding and storage of the first main support frame.

Further, a bottom end of the first main support frame is bent, such that the first main support frame is folded and stored above the hinge seat. That is, the first main support frame can be supported through the hinge seat.

Beneficial Effects:
(1) The position of the first support frame on the side rail is adjustable to ensure that the first main support frame is close to the cab in a supporting state and avoids the cab in a folded state such that the first main support frame can be folded flat. The design ensures good folding and storage as well as support effect. The second folding assembly is stored above the first folding assembly, occupying less space.
(2) The second main support frame is bent, such that the portion of the second folding assembly folded and stored above the first folding assembly is in a flat state. After being folded and stored, the first folding assembly and the second folding assembly are roughly stacked horizontally. The design is easy for binding and fixing. In addition, the support frames are pressed against each other, which will not cause the support frames to shake or collide with each other. Furthermore, in the present disclosure, the support mechanism is laid flat behind the cab after being folded and stored, reducing air resistance.
(3) Each main support frame is provided with an auxiliary support frame, and the support points are evenly distributed to enhance the support effect.

### BRIEF DESCRIPTION OF THE DRAWINGS

To describe the technical solutions in the embodiments of the present disclosure more clearly, the following briefly introduces the drawings required for describing the embodiments. Apparently, the drawings in the following description show merely some embodiments of the present disclosure, and those of ordinary skill in the art may still derive other drawings from these drawings without creative efforts.

FIG. 1 is a three-dimensional schematic diagram of a support mechanism for a soft top of a truck bed in a supporting state according to the present disclosure;

FIG. 2 is an enlarged view of A shown in FIG. 1;

FIG. 3 is a lateral view of the support mechanism for a soft top of a truck bed in the supporting state according to the present disclosure;

FIG. 4 is a three-dimensional schematic diagram of the support mechanism for a soft top of a truck bed in a folded state according to the present disclosure; and

FIG. 5 is an enlarged view of B shown in FIG. 4.

Reference Numerals: 1. side rail; 2. first folding assembly; 2-1. first main support frame; 2-2. first auxiliary support frame; 3. second folding assembly; 3-1. second main support frame; 3-2. second auxiliary support frame; 4. rotating rod; 5. hinge seat; 6. support strap; and 7. fixture.

### DETAILED DESCRIPTION OF THE EMBODIMENTS

The technical solutions in embodiments of the present disclosure will be described below clearly and completely with reference to the drawings in the embodiments of the present disclosure. Apparently, the described embodiments are merely some, rather than all of the embodiments of the present disclosure. The following description of at least one exemplary embodiment is merely illustrative, and not intended to limit the present disclosure and application or use thereof in any way. All other embodiments obtained by those of ordinary skill in the art based on the embodiments of the present disclosure without creative efforts shall fall within the protection scope of the present disclosure.

It should be noted that the terminology used herein is for the purpose of describing particular embodiments only and is not intended to limit exemplary embodiments according to the present disclosure. As used herein, unless otherwise specified herein, the singular forms are also intended to include the plural forms. In addition, it should also be understood that when the terms “comprise” and/or “include” are used in this specification, they specify the presence of features, steps, operations, devices, components, and/or combinations thereof.

The relative arrangement of the components and steps, the numerical expressions and numerical values set forth in these embodiments do not limit the scope of the present disclosure unless specifically stated otherwise. Meanwhile, it should be understood that for ease of description, each portion in the drawings is not necessarily drawn to the actual scale. The technologies, methods, and devices known to those of ordinary skill in the art may not be discussed in detail, but where appropriate, the technologies, methods, and devices should be regarded as part of the specification. In all examples shown and discussed herein, any specific value should be interpreted as merely exemplary, rather than restrictive. Therefore, other examples of the exemplary embodiments may have different values. It should be noted that similar reference signs and letters represent similar items in the drawings below. Therefore, once an item is defined in one drawing, it does not need to be further discussed in subsequent drawings.

It should be understood that in the description of the present disclosure, orientation terms such as “front”, “rear”, “upper”, “lower”, “left”, “right”, “transverse”, “longitudinal”, “vertical”, “horizontal”, “top” and “bottom” indicate orientation or position relationships based on the drawings. Unless otherwise specified, these orientation terms are merely intended to facilitate or simplify the description of the present disclosure, rather than to indicate or imply that the mentioned device or elements must have a specific orientation and must be constructed and operated in a specific orientation. Therefore, they should not be construed as a limitation to the protection scope of the present disclosure. The orientation terms “inner” and “outer” refer to the inner and outer parts relative to the contour of the mentioned component.

For ease of description, spatially relative terms, such as “above”, “on the upper side of”, “on the upper surface of” and “on”, can be used to describe the spatial positional relationship between components or features shown in the figure. It should be understood that the spatially relative terms are intended to encompass different orientations of the components in use or operation in addition to those shown in the figure. For example, if a component in the figure is inverted, it is described as a component “above other component or structure” or “on other component or structure”. Therefore, the component will be positioned as “below other component or structure” or “under other component or structure”. Therefore, the exemplary term “above” may include both orientations “above” and “below”. The component may also be positioned in other different ways (rotated by 90 degrees or in other orientations), but the relative description of the space should be explained accordingly.

In addition, it should be noted that the use of words such as “first” and “second” to define parts and components is only for the convenience of distinguishing corresponding parts and components. Unless otherwise stated, the above words have no special meaning, so they should not be construed as a limitation on the protection scope of the present disclosure.

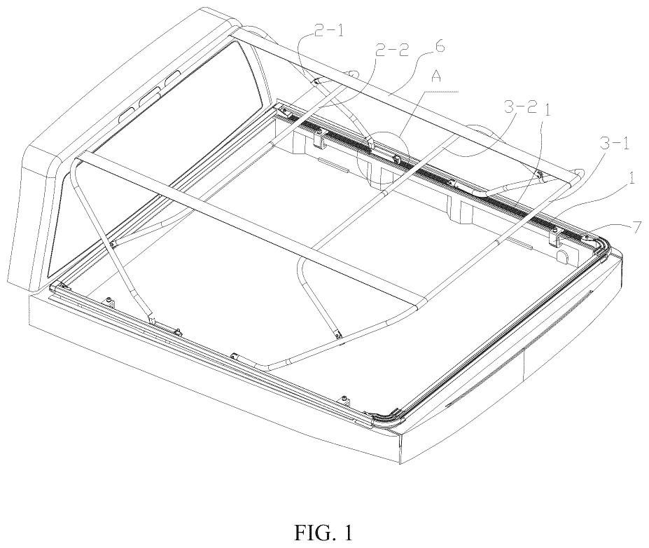

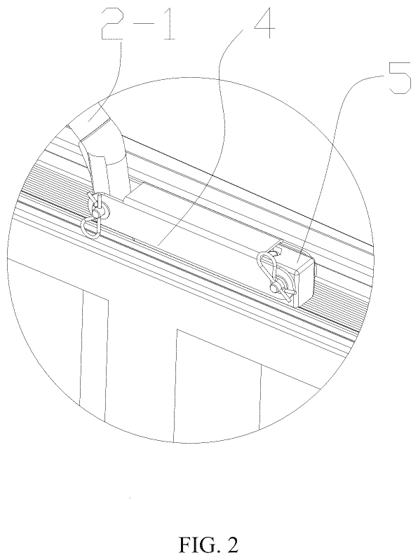

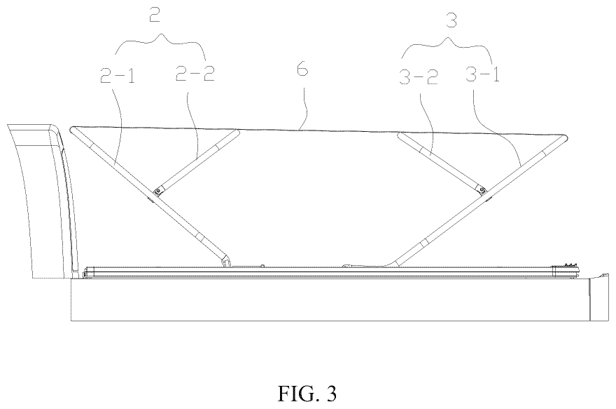

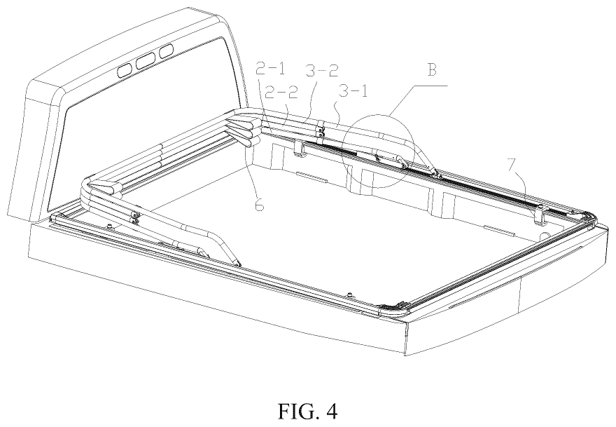

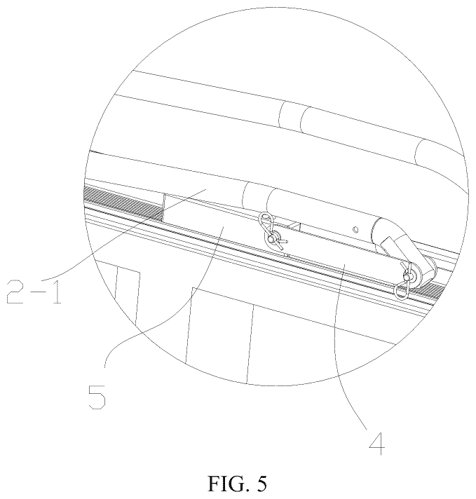

As shown in FIGS. 1 to 5, the present disclosure provides a support mechanism for a soft top of a truck bed. The support mechanism is configured to support a soft top fabric, and includes side rail 1, first folding assembly 2, and second folding assembly 3. The side rail 1 is fixed to the truck bed through fixture 7. The first folding assembly 2 includes first main support frame 2-1. The first main support frame 2-1 is rotatably provided on the side rail 1. A bottom end of the first main support frame 2-1 is connected to a movable component. The first main support frame 2-1 is rotatably connected to the movable component. Of course, other connection means can also be used, such as detachable connection. The movable component is rotatably connected to the side rail 1, such that the bottom end of the first main support frame 2-1 is adjustable at least along a length direction of the side rail 1. When the first main support frame 2-1 is stored, the movable component rotates towards a rear of a pickup truck. In this way, the first main support frame 2-1 is rotatable forward for storage without interfering with a cab.

The second folding assembly 3 includes second main support frame 3-1. The second main support frame 3-1 is rotatably provided on the side rail 1. The second folding assembly 3 is foldable and storable above the first folding assembly 2. Preferably, the second main support frame 3-1 is bent, such that a portion of the second folding assembly 3 folded and stored above the first folding assembly 2 is in a flat state.

The first folding assembly 2 further includes at least one first auxiliary support frame 2-2 provided on the first main support frame 2-1. The first auxiliary support frame 2-2 and the first main support frame 2-1 are rotatably connected and each are provided with a first positioning structure. The first positioning structure can include a screw and a nut located at a hinge joint of the first auxiliary support frame 2-2. Similarly, a screw and a nut at a hinge joint of the first main support frame 2-1 or the second main support frame 3-1 can be tightened and positioned in a supporting state.

The second folding assembly 3 further includes at least one second auxiliary support frame 3-2 provided on the second main support frame 3-1. The second auxiliary support frame 3-2 and the second main support frame 3-1 are rotatably connected and each are provided with a second positioning structure. The second positioning structure can include a screw and a nut provided at a hinge point of the second auxiliary support frame 3-2.

The support mechanism further includes support strap 6. One end of the support strap 6 is fixed to the first main support frame 2-1, and the other end of the support strap 6 is fixed to the second main support frame 3-1.

A bottom of the first main support frame 2-1 can be provided with a bend, such that the first main support frame is overlapped horizontally on hinge seat 5 for folded storage. Of course, the first main support frame 2-1 can also be directly overlapped on the side rail 1 or on a side frame close to the cab.

Due to the bending angle of the second main support frame 3-1, in folded storage, the second main support frame 3-1, the second auxiliary support frame 3-2, the first auxiliary support frame 2-2, and the first main support frame 2-1 are stacked from top to bottom in a roughly horizontal state, saving space.

In another embodiment of the present disclosure, the side rail 1 is further provided with rotating rod 4. The side rail 1 is fixed to or integrated with the hinge seat 5. Optionally, the hinge seat 5 is fixedly connected to the side rail 1 through a screw. A first end of the rotating rod 4 is hinged to the hinge seat 5, and the other end of the rotating rod 4 is hinged to the first main support frame 2-1. When the support mechanism is in the supporting state, the rotating rod 4 is located at a front side. As the soft top needs to be fixed to the truck bed, it will press down on the entire support mechanism. Therefore, the rotating rod 4 does not rotate, eliminating the need for an additional fixing mechanism. When storage is needed, the rotating rod 4 rotates 180° to a rear side, and the first main support frame 2-1 hinged to the rotating rod 4 is flipped forward for storage. This step does not require disassembly or repositioning, making it easy to operate. The bottom end of the first main support frame 2-1 is bent, such that the first main support frame 2-1 is folded and stored above the hinge seat 5. In the embodiment of the present disclosure, the support assembly for supporting the soft top may include two first folding assemblies 2, one at the front side and the other at the rear side. In case of storage, the rotating rod 4 rotates in an opposite direction towards the interior of the pickup, such that the first folding assembly 2 does not exceed the side frame of the truck bed after being stored. Of course, the support assembly can also adopt a combination of the first folding assembly 2 and the second folding assembly 3 shown in FIGS. 1 to 5.

The above merely describes specific implementations of the present disclosure, but the protection scope of the present disclosure is not limited thereto. Those skilled in the art can easily conceive modifications or replacements according to the technical solutions and ideas of the present disclosure within the technical scope of the present disclosure, and these modifications or replacements shall fall within the protection scope of the present disclosure.

What is claimed is:

1. A support mechanism for a soft top of a truck bed, comprising:
a side rail, fixed to the truck bed; and
a first folding assembly, comprising a first main support frame;
wherein a bottom end of the first main support frame is connected to a movable component; and the movable component is rotatably connected to the side rail, wherein the bottom end of the first main support frame is adjustable at least along a length direction of the side rail.

2. The support mechanism for the soft top of the truck bed according to claim 1, further comprising a second folding assembly, wherein the second folding assembly comprises a second main support frame; the second main support frame is rotatably provided on the side rail; and the second folding assembly is foldable and storable above the first folding assembly.

3. The support mechanism for the soft top of the truck bed according to claim 2, wherein the second main support frame is bent, wherein a portion of the second folding assembly folded and stored above the first folding assembly is in a flat state.

4. The support mechanism for the soft top of the truck bed according to claim 2, wherein the first folding assembly further comprises at least one first auxiliary support frame provided on the first main support frame.

5. The support mechanism for the soft top of the truck bed according to claim 4, wherein the first auxiliary support frame and the first main support frame are rotatably connected and each are provided with a first positioning structure.

6. The support mechanism for the soft top of the truck bed according to claim 2, wherein the second folding assembly further comprises at least one second auxiliary support frame provided on the second main support frame.

7. The support mechanism for the soft top of the truck bed according to claim 6, wherein the second auxiliary support frame and the second main support frame are rotatably connected and each are provided with a second positioning structure.

8. The support mechanism for the soft top of the truck bed according to claim 2, further comprising a support strap, wherein the support strap comprises a first end fixed to the first main support frame and a second end fixed to the second main support frame.

9. The support mechanism for the soft top of the truck bed according to claim 1, wherein the side rail is fixed to the truck bed through a fixture.

10. A support assembly for a soft top of a truck bed, comprising:
a side rail, fixed to the truck bed; and
a first folding assembly, comprising a first main support frame; and
a rotating rod, wherein the side rail is fixed to or integrated with a hinge seat; and the rotating rod comprises a first end hinged to the hinge seat and a second end hinged to the first main support frame.

11. The support assembly for the soft top of the truck bed according to claim 10, wherein a bottom end of the first main support frame is bent, wherein the first main support frame is folded and stored above the hinge seat.
